(19) United States
(12) Patent Application Publication
(10) Pub. No.: US 2025/0252323 A1
(43) Pub. Date: Aug. 7, 2025

(54) COMPUTING SYSTEM AND METHOD FOR APPLYING PRECOMPUTATION OF COALITIONS AND ACCELERATED SAMPLING TO DETERMINE THE CONTRIBUTION OF INPUT VARIABLES ON THE OUTPUT OF A DATA SCIENCE MODEL VIA MONTE CARLO ESTIMATION

(71) Applicant: Discover Financial Services, Riverwoods, IL (US)

(72) Inventors: Alexey Miroshnikov, Scottsdale, AZ (US); Konstandinos Kotsiopoulos, Easthampton, MA (US); Arjun Ravi Kannan, Buffalo Grove, IL (US)

(21) Appl. No.: 18/435,837

(22) Filed: Feb. 7, 2024

(51) Int. Cl. G06N 5/022

(52) U.S. Cl. CPC G06N 5/022

(57) ABSTRACT

A computing platform is configured to (i) generate a set of variable coalitions by randomly sampling from a variable-dependent distribution of a input variables, (ii) identify a given input data record to be scored by a trained model object, (iii) generate a set of variable-independent synthetic samples (iv) execute the model object to output a score for each variable-independent synthetic sample, (v) for each respective input variable, (a) generate a variable-dependent set of synthetic samples, (b) execute the model object to output a set of scores for each variable-dependent synthetic sample, (c) evaluate a difference between the set of scores for each variable-dependent synthetic sample and the corresponding set of scores for each variable-independent synthetic sample, and (d) determine a set of iteration-specific contribution values for the respective input variable, and (vi) for each respective input variable, average the iteration-specific contribution values and thereby determine an aggregated contribution value.

### BACKGROUND

An increasing number of technology areas are becoming driven by data and the analysis of such data to develop insights. One way to do this is with data science models that may be created based on historical data and then applied to new data to derive insights such as predictions of future outcomes.

In many cases, the use of a given data science model is accompanied by a desire to explain the output of the model, such that an appropriate action might be taken in view of the insight provided. However, many data science models are extremely complex and the manner by which they derive insights can be difficult to analyze. For example, it may not be apparent how the output of a data science model was affected, if at all, by a given input variable of the data science model. Therefore, it can be difficult to interpret what input variables had the greatest effect on the output generated by the model. This task is made even more complicated when considering the dependency among groups of input variables, which, if not accounted for, can lead to less reliable results.

### Overview

Disclosed herein is a new technique for determining contribution values for input variables of a trained data science model by leveraging the precomputation of random variable coalitions that are independent the input variable of interest.

In one aspect, the disclosed technology may take the form of a method to be carried out by a computing platform that involves (i) training a model object for a data science model using a machine learning process, wherein the model object is trained to (a) receive an input data record comprising a set of input variables and (b) output a score for the input data record, (ii) obtaining a set of historical data records, (iii) generating a set of variable coalitions by randomly sampling from a distribution of the set of input variables, wherein the distribution is independent of any input variable, (iv) identifying a given input data record to be scored by the model object, (v) generating a set of synthetic samples that is independent of any input variable, the set of synthetic samples generated based on (a) the given input data record, (b) the set of historical data records, and (c) the set of variable coalitions, (vi) executing the model object to output a respective score for each synthetic sample in the set of synthetic samples, (vii) for each respective input variable of the model object, (a) inserting the respective input variable from the input data record into each synthetic sample that does not already include the respective input variable, thereby generating a variable-dependent set of synthetic samples, (b) executing the model object to output a set of scores for each variable-dependent synthetic sample in the set of variable-dependent synthetic samples, (c) evaluating a difference between the set of scores for each variable-dependent synthetic sample in the set of variable-dependent synthetic samples and the corresponding set of scores for each synthetic sample in the set of synthetic samples, and (d) determining a set of iteration-specific contribution values for the respective input variable by applying a factor to the difference, the factor based on a total number of input variables in the set of input variables and a size of the corresponding respective coalition in the set of variable coalitions, and (viii) for each respective input variable of the model object, averaging the iteration-specific contribution values determined for each iteration and thereby determine an aggregated contribution value for the respective input variable.

In some example embodiments, generating a set of variable coalitions may involve generating a matrix of variable coalitions, where each row in the matrix is a vector of 1's and 0's that represent, for a corresponding coalition in the set of variable coalitions, a respective presence or absence of a given input variable in the variable coalition.

Further, in example embodiments, generating the matrix of variable coalitions may involve, for each variable coalition in the set of variable coalitions, (i) randomly generating a number of input variables in the variable coalition and (ii) inserting, into the corresponding row of the matrix of variable coalitions that corresponds to the variable coalition, the number of 1's into randomly selected columns of the corresponding row, leaving all other columns 0.

Further yet, in example embodiments, the method may involve storing the matrix of variable coalitions for reuse by the computing platform.

Still further, in some example embodiments, the method may involve generating a matrix of partial synthetic samples that exclude a portion of each synthetic sample from the corresponding coalition, where the matrix of partial synthetic samples includes (i) a 0 where each row in the matrix of variable coalitions includes a 1 and (ii) a corresponding variable from the set of historical data records where each row in the matrix of variable coalitions includes a 0.

Still further, in some example embodiments, generating the set of synthetic samples that is independent of any input variable may involve generating a matrix of variable-independent synthetic samples, where each row in the matrix of variable-independent synthetic samples corresponds to a respective variable-independent synthetic sample and includes (i) a corresponding variable from the given input data record where each row in the matrix of variable coalitions includes a 1 and (ii) a corresponding variable from the set of historical data records where each row in the matrix of variable coalitions includes a 0.

Still further, in some example embodiments, the set of input variables includes one thousand or more input variables.

Still further, in some example embodiments, the set of historical data records includes one million or more historical data records.

In yet another aspect, disclosed herein is a computing platform that includes a network interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of one or both of the foregoing methods.

In still another aspect, disclosed herein is a non-transitory computer-readable medium provisioned with program instructions that, when executed by at least one processor, cause a computing platform to carry out the functions disclosed herein, including but not limited to the functions of one or both of the foregoing methods.

One of ordinary skill in the art will appreciate these as well as numerous other aspects in reading the following disclosure.

In yet another aspect, disclosed herein is a computing platform that includes a network interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In still another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts a simplified block diagram illustrating an example computing environment in which a data science model may be utilized.

FIG. 2 depicts a simplified block diagram illustrating an example data science model that may be executed by a software subsystem of a computing platform according to aspects of the disclosed technology;

FIG. 3 is a flow chart that illustrates one possible example of a process for approximating contribution values using precomputed coalitions, in accordance with the present disclosure;

FIG. 4A depicts an example set of historical data records X_{mc} and an example set of variable coalitions S, in accordance with the present disclosure;

FIG. 4B depicts an example product of the set of historical data records X_{mc} and the set of variable coalitions S and an example variable-independent set of synthetic samples x_{synth}, in accordance with the present disclosure;

FIG. 4C depicts an example variable-dependent set of synthetic samples \tilde{x}_{synth,1} for a first input variable and an example variable-dependent set of synthetic samples \tilde{x}_{synth,2} for a second input variable, in accordance with the present disclosure;

FIG. 5 is a simplified illustration of a set of contribution values that may be determined for individual input variables for a model object; and

FIG. 6 is a simplified block diagram that illustrates some structural components of an example computing platform.

### DETAILED DESCRIPTION

Organizations in various industries have begun to utilize data science models to derive insights that may enable those organizations, and the goods and/or services they provide, to operate more effectively and/or efficiently. The types of insights that may be derived in this regard may take numerous different forms, depending on the organization utilizing the data science model and the type of insight that is desired. As one example, an organization may utilize a data science model to predict the likelihood that an industrial asset will fail within a given time horizon, based on operational data for the industrial asset (e.g., sensor data, actuator data, etc.). As another example, data science models may be used in a medical context to predict the likelihood of a disease or other medical condition for an individual, and/or the result of a medical treatment for the individual.

As yet another example, many organizations have begun to utilize data science models to help make certain business decisions with respect to prospective or existing customers of those companies. For instance, as one possibility, an organization may utilize a data science model to help make decisions regarding whether to extend a service provided by that organization to a particular individual. One example may be an organization that provides financial services such as loans, credit card accounts, bank accounts, or the like, which may utilize a data science model to help make decisions regarding whether to extend one of these financial services to a particular individual (e.g., by estimating a risk level for the individual and using the estimated risk level as a basis for deciding whether to approve or deny an application submitted by the individual). As another possibility, an organization may utilize a data science model to help make decisions regarding whether to target a particular individual when engaging in marketing of a good and/or service that is provided by the company (e.g., by estimating a similarity of the individual to other individuals who previously purchased the good and/or service). As yet another possibility, a company may utilize a data science model to help make decisions regarding what terms to offer a particular individual for a service provided by the organization, such as what interest rate level to offer a particular individual for a new loan or a new credit card account. Many other examples are possible as well.

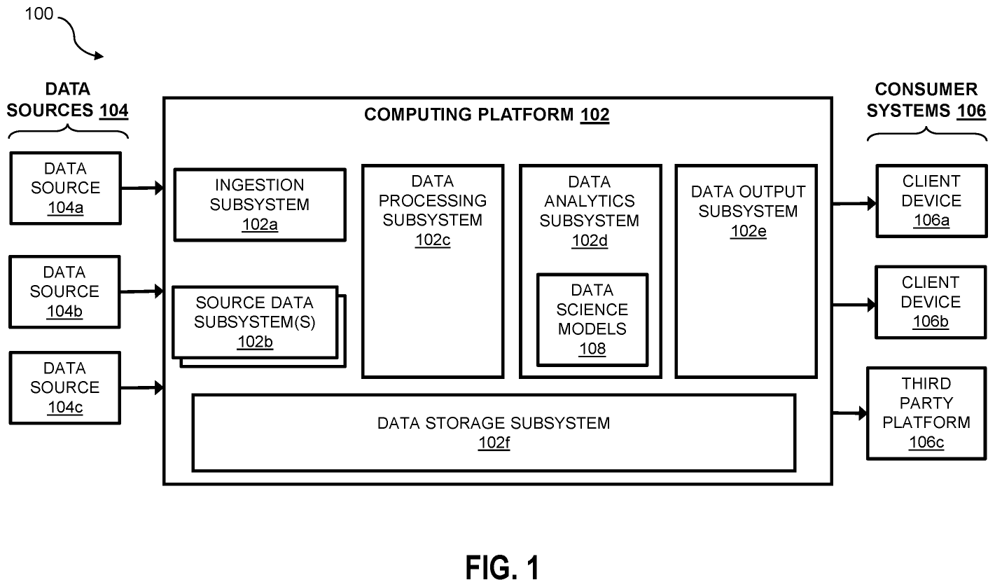

One illustrative example of a computing environment 100 in which an example data science model such as this may be utilized is shown in FIG. 1. As shown, the example computing environment 100 may include a computing platform 102 associated with a given organization, which may comprise various functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of organization operating the example computing platform 102.

Further, as shown in FIG. 1, the example computing platform 102 may comprise one or more source data subsystems 102b that are configured to internally generate and output source data that is consumed by the example computing platform 102. These source data subsystems 102b may take any of various forms, which may depend at least in part on the type of organization operating the example computing platform 102.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of organization operating the example computing platform 102. For instance, in line with the present disclosure, data analytics subsystem 102d may be configured to execute data science models 108 for rendering decisions related to the organization's business, such as a data science model for deciding whether to extend a service being offered by the organization to an individual within a population (e.g., a financial service such as a loan, a credit card account, a bank account, etc.), a data science model for deciding whether to target an individual within a population when engaging in marketing of a good and/or service that is offered by the organization, and/or a data science model for deciding what terms to extend an individual within a population for a service being offered by the organization, among various other possibilities. In practice, each such data science model 108 may comprise a model object that was trained by applying a machine learning process to a training dataset, although it should be understood that a data science model could take various other forms as well.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the organization (e.g., employees, contractors, etc.) and/or individuals seeking to obtain goods and/or services from the organization. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices, among other possibilities.

The data output subsystem 102e may be configured to output data to other types of consumer systems 106 as well.

Referring once more to FIG. 1, the example computing platform 102 may also comprise a data storage subsystem 102f that is configured to store all of the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, communication interfaces, etc.) that are utilized to implement the functional subsystems discussed herein. This set of physical computing resources take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise “on-premises” computing resources of the organization that operates the example computing platform 102 (e.g., organization-owned servers). As yet another possibility, the example computing platform 102 may comprise a combination of cloud computing resources and on-premises computing resources. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

It should be understood that computing environment 100 is one example of a computing environment in which a data science model may be utilized, and that numerous other examples of computing environment are possible as well.

Most data science models today comprise a trained model object (sometimes called a trained “regressor”) that is configured to (i) receive input data for some set of input variables, (ii) evaluate the input data, and (iii) based on the evaluation, output a “score” (e.g., a likelihood value). For at least some data science models, the score is then used by the data science model to make a classification decision, typically by comparing the score to a specified score threshold, depending on the application of the data science model in question.

These types of trained model objects are generally created by applying a machine learning process to a training dataset that is relevant to the particular type of classification decision to be rendered by the data science model (e.g., a set of historical data records that are each labeled with an indicator of a classification decision based on the historical data record). In this respect, the machine learning process may comprise any of various machine learning techniques, examples of which may include regression techniques, decision-tree techniques, support vector machine (SVM) techniques, Bayesian techniques, ensemble techniques, gradient descent techniques, and/or neural network techniques, among various other possibilities.

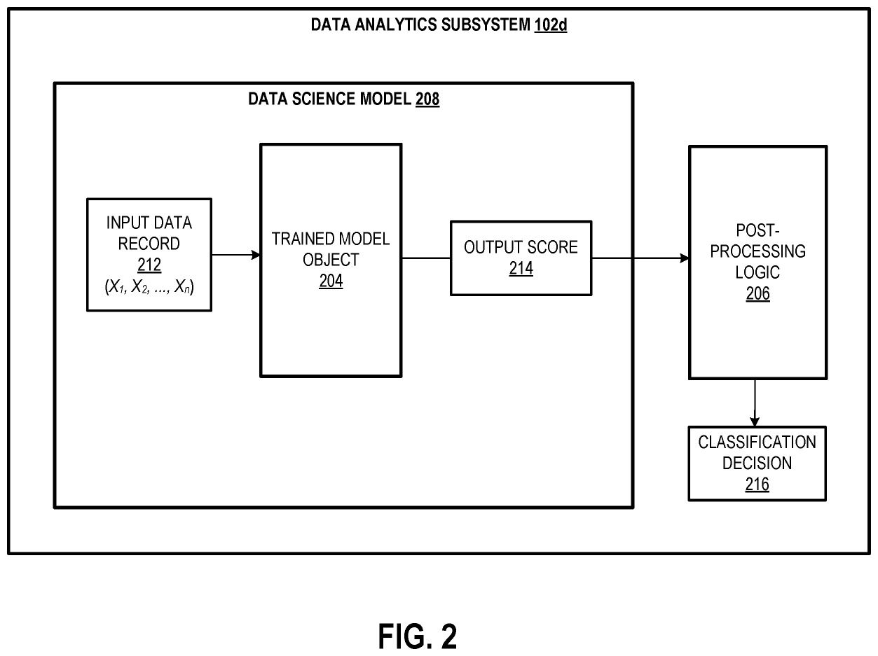

FIG. 2 depicts a conceptual illustration of a data science model 208 for making a classification decision 216 for an input data record 212 in accordance with the present disclosure, which may also be referred to herein as a “classification score” model. In the example of FIG. 2, the data science model 208 is shown as being deployed within the example computing platform 102 of FIG. 1, and in particular the data analytics subsystem 102d of the computing platform 102 of FIG. 1, but it should be understood that the data science model 208 may be deployed within any computing platform that is capable of executing the disclosed data science model 208.

The type of classification decision that is made by the data science model 208 shown in FIG. 2 may take various forms, as noted above. However, for the purposes of FIG. 2 and the examples that follow, the data science model 208 will be referred to as a model for estimating the risk associated with a given individual in order to make a decision regarding whether to extend a service being offered by an organization to the individual (e.g., a financial service such as a loan, a credit card account, a bank account, etc.).

As shown in FIG. 2, the data science model 208 may include a trained model object 204 that functions to receive the input data record 212. The input data record 212 includes data for a set of input variables (sometimes also referred to as “feature variables,” “features,” or “predictors”) that are used by the trained model object 204 and are represented in FIG. 2 by the set of variables (X₁, X₂, . . . , Xₙ). In this regard, the input data record 212 may include data corresponding to a given individual for whom a classification decision will be made, and may generally comprise data for any variables that may be predictive of the risk associated with the given individual (e.g., variables that provide information related to credit score, credit history, loan history, work history, income, debt, assets, etc.).

In some implementations, the data science model 208 may initially receive source data (e.g., from one or more of the data sources 104 shown in FIG. 1) that may not correspond directly to the input variables used by the trained model object 204, and/or may include extraneous data that is not used by the trained model object 204, and so on. In these situations, the data science model 208 may first apply pre-processing logic (not shown) to derive, from the source data, the data for the particular input variables that are used by the trained model object 204. In other implementations, the data processing subsystem 102c shown in FIG. 1 may receive the source data from which the input variables are derived and may perform some or all of the pre-processing logic discussed above before passing the result to the data analytics subsystem 102d and the data science model 208. Other implementations are also possible.

Once the input data record 212 including the input variables (X₁, X₂, . . . , Xₙ) is received by the trained model object 204 as input, the trained model object 204 may evaluate the input variables. Based on the evaluation, the trained model object 204 may determine and output a score 214 that represents the risk associated with the given individual. For example, the output score 214 may represent a probability (e.g., a value between 0 and 1) that the given individual will default on a loan if the loan is extended to the given individual. As further shown in FIG. 2, the data analytics subsystem 102d may then apply post-processing logic 206 to the output score 214 of the data science model 208 in order to render a classification decision 216. For instance, if the output score 214 is above a given high-risk threshold, the data analytics subsystem 102d may render a decision not to extend the loan to the individual (e.g., to deny the individual's application for the loan). As another possibility, if the output score 214 is below the given high-risk threshold, and additionally below a given preferred-rate threshold, the data analytics subsystem 102d may render a decision to approve the individual's loan application at a lower interest rate than may be offered to another approved individual for whom the trained model object 204 output a score above the preferred-rate threshold. Various other examples are also possible.

There are various advantages to using a data science model comprising a trained model object over other forms of data analytics that may be available. As compared to human analysis, data science models can drastically reduce the time it takes to make decisions. In addition, data science models can evaluate much larger datasets (e.g., with far more input variables) while simultaneously expanding the scope and depth of the information that can be practically evaluated when making decisions, which leads to better-informed decisions. Another advantage of data science models over human analysis is the ability of data science models to reach decisions in a more objective, reliable, and repeatable way, which may include avoiding any bias that could otherwise be introduced (whether intentionally or subconsciously) by humans that are involved in the decision-making process, among other possibilities.

Data science models may also provide certain advantages over alternate forms of machine-implemented data analytics like rule-based models (e.g., models based on user-defined rules). For instance, unlike most rule-based models, data science models are created through a data-driven process that involves analyzing and learning from historical data, and as a result, data science models are capable of deriving certain types of insights from data that are simply not possible with rule-based models-including insights that are based on data-driven predictions of outcomes, behaviors, trends, or the like, as well as other insights that can only be revealed through an understanding of complex interrelationships between multiple different data variables. Further, unlike most rule-based models, data science models are capable of being updated and improved over time through a data-driven process that re-evaluates model performance based on newly-available data and then adjusts the data science models accordingly. Further yet, data science models may be capable of deriving certain types of insights (e.g., complex insights) in a quicker and/or more efficient manner than other forms of data analytics such as rule-based models. Depending on the nature of the available data and the types of insights that are desired, data science models may provide other advantages over alternate forms of data analytics as well.

When using a data science model comprising a trained model object, there may be a need to quantify or otherwise evaluate the extent to which the model object's different input variables contribute to the model object's output. This type of analysis of the contribution (sometimes also referred to as attribution) of the input variables to a model's output may take various forms.

For instance, it may be desirable in some situations to determine which input variable(s) contribute most heavily to a decision made based on a model object's output on a prediction-by-prediction basis. Additionally, or alternatively, it may be desirable in some situations to determine which input variable(s) contribute most heavily, on average, to the decisions made based on a model object's output over some representative timeframe.

As one example, and referring to the discussion of FIG. 2 above, financial services companies that deny applications for credit (e.g., loan applications) are subject to regulations that require the companies to inform the denied individuals as to which factors contributed most to that decision. In this regard, the factors provided to the applicant can be referred to as Model Reason Codes (MRCs), sometimes referred to as simply “reason codes.” Consequently, a financial services company that utilizes a data science model to make these types of classification decisions must also be prepared to interpret the resulting decisions and identify the corresponding reason codes.

As another example, an organization that manages industrial assets may want to determine the input variable(s) that contributed most to a failure prediction for a given asset. For instance, an input variable corresponding to particular sensor data or actuator data gathered from the industrial asset may have the greatest contribution to the predicted failure. This information, in turn, may then help guide the remedial action that may be taken to avoid or fix the problem before the failure occurs in the given asset and/or in other similarly situated assets.

As yet another example, a medical organization that uses data science models to predict the likelihood of disease or other medical conditions for individuals may want to determine the input variable(s) that contributed most to the model's output score for a given individual. This information may then be used to make judgments about the treatments for the individual that may be effective to reduce the likelihood of the disease or medical condition.

Another situation where it may be desirable to analyze the contribution of a model object's input variables to the model's output is to determine which input variable(s) contribute most heavily to a bias exhibited by the model object. At a high level, this may generally involve (i) using the model object to score input datasets for two different subpopulations of people (e.g., majority vs. minority subpopulations), (ii) quantifying the contributions of the input variables to the scores for the two different subpopulations, and (iii) using the contribution values for the two different subpopulations to quantify the bias contribution of the variables.

Further details regarding these and other techniques for determining which input variable(s) contribute most heavily to a bias exhibited by a model object can be found in U.S. patent application Ser. No. 17/900,753, which was filed on Aug. 31, 2022 and is entitled “COMPUTING SYSTEM AND METHOD FOR CREATING A DATA SCIENCE MODEL HAVING REDUCED BIAS” and which is incorporated herein by reference in its entirety.

To this end, several techniques have been developed for quantifying the contribution of a trained model object's input variables. These techniques, which are sometimes referred to as “interpretability” techniques or “explainer” techniques, may take various forms. As one example, a technique known as Local Interpretable Model-agnostic Explanations (LIME) uses a linear function as a local approximation for a model object, and then uses the linear function as a surrogate model for explaining the output. Another example technique is Partial Dependence Plots (PDP), which utilizes the model object directly to generate plots that show the impact of a subset of the input variables in the overall input data record (also referred to as the “predictor vector”) on the output of the model object. PDP is similar to another technique known as Individual Conditional Expectation (ICE) plots, except an ICE plot is generated by varying a single input variable given a specific instance of the input variable, whereas a PDP plot is generated by varying a subset of the input variables after the complementary set of variables has been averaged out. Another technique known as Accumulated Local Effects (ALE) takes PDP a step further and partitions the predictor vector space and then averages the changes of the predictions in each region rather than the individual input variables.

Yet another explainer technique is based on the game-theoretic concept of the Shapley value (Shapley, 1953). Given a cooperative game with n players, a set function ν that acts on a set N: ={1, 2, . . . n} and satisfies ν(∅)=0, the Shapley value assigns contributions to each player i∈N to the total payoff ν(N), and is given by

$${φ}_{i} [ v ] = {\sum }_{S ⊆ N ∖ \{ i \}} \frac{s ! ( n - s - 1 ) !}{n !} ( v ( S ⋃ \{ i \} ) - v ( S ) ) , s := \vert S \vert , n := \vert N \vert \qquad ( Eq . 1 )$$

by considering all the different combinations between a player i and the rest of the players.

In the machine learning (ML) setting, the features X=(X₁, X₂, . . . Xₙ) are viewed as n players with an appropriately designed game ν(S;x,X,ƒ) where x is an observation (a predictor sample from the training dataset of features D_{X}), X is a random vector of features, and ƒ corresponds to the model object and S⊆N. The choice of the game is crucial for a game-theoretic explainer, as it determines the meaning of the attribution (explanation) value. See the paper entitled “Mutual information-based group explainers with coalition structure for ML model explanations” by Miroshnikov et al., which has a last revised date of Oct. 5, 2022 and can be found at https://arxiv.org/abs/2102.10878, which is incorporated herein by reference in its entirety. Two of the most notable games in the ML literature are the conditional and marginal games given by

$${v}^{CE} ( S ; x , X , f ) = 𝔼 [ f ( X ) \vert {X}_{S} = {x}_{S} ] and \qquad ( Eq . 2 )$$

$${v}^{ME} ( S ; x , X , f ) = 𝔼 [ f ( {x}_{S} , {X}_{- S} ) ] \qquad ( Eq . 3 )$$

introduced in E. Strumbelj, I. Kononenko, “An efficient explanation of individual classifications using game theory” Journal of Machine Learning Research, 11, pp. 1-18, (2010) and refined in S. M. Lundberg and S.-I. Lee, “A unified approach to interpreting model predictions”, 31st Conference on Neural Information Processing Systems, (2017), both of which are incorporated by reference herein in their entirety. Shapley values of the conditional game—i.e., conditional Shapley values—explain predictions ƒ(X) viewed as a random variable, while Shapley values for the marginal game—i.e., marginal Shapley values—explain the (mechanistic) transformations occurring in the model ƒ(x).

In practice, conditional or marginal games are typically replaced with their empirical analogs that utilize data samples. Computing conditional game values is, in general, infeasible when the predictor dimension is large considering the curse of dimensionality. The marginal game, however, is often approximated with the empirical marginal game \hat{ν}^{ME}(S;x,D̅_{X},ƒ) given by

$${\hat{v}}^{ME} ( S ; x , {\overline{D}}_{X} , f ) := \frac{1}{\vert {\overline{D}}_{X} \vert} {\sum }_{\tilde{x} ∈ {\overline{D}}_{X}} f ( {x}_{S} , {\tilde{x}}_{- S} ) \qquad ( Eq . 4 )$$

where D̅_{X} is a background dataset of vector of features, a subset of the dataset D_{X} containing a vector of features X used for training (e.g., the input data record 212 shown in FIG. 2, including samples of input variables X₁, X₂, . . . Xₙ stored in D_{X}).

The marginal Shapley value φᵢ[ν^{ME}] of the feature indexed by i, that is the Shapley value for the game ν^{ME}(S;x,X,ƒ), takes into account all the different combinations between a feature of interest (e.g., the input variable whose contribution is to be determined) and the rest of the features in the input vector and produces a score (e.g., a scalar value) that represents the contribution of that feature value to the deviation of the model prediction for the specific instance of the input vector from the model's average prediction. The empirical marginal Shapley value φᵢ[\hat{ν}^{ME}] is the statistical approximant of φᵢ[ν^{ME}], which has complexity of the order O(2ⁿ·|D_{X}|), the number of terms in the Shapley formula times the number of evaluations over the size of the dataset D_{X}.

In the remaining parts of the document when we refer to Shapley values (or marginal Shapley values), we mean the Shapley values φᵢ[ν^{ME}], i=1, 2, . . . n, of the marginal game and we denote them by φᵢ^{ME} or φᵢ^{ME}(x) where we suppress the information on the model ƒ and the random variable X.

Marginal Shapley values, as discussed herein, generate individual contributions of predictor values. It will be appreciated that the marginal Shapley value is, in general, impossible to compute because it requires knowledge of the distribution of X. While the evaluation of the empirical marginal game \hat{ν}^{ME}(S;x,D̅_{X},ƒ) is relatively cheap (if the background dataset is small), to evaluate the empirical marginal Shapley value itself is expensive to compute because the Shapley value formula contains the summation over all coalitions S∪N, leading to 2ⁿ terms. The complexity can then become extreme if the number of features n is large. If the background dataset is large (e.g., it is chosen to be the training dataset) then evaluating the empirical marginal game alone also becomes expensive.

One practical implementation of using Shapley values to quantify variable contributions is an algorithm referred to as kernel SHAP, described in Lundberg and Lee (2017). KernelSHAP is utilized to compute the marginal Shapley value for each input variable. The KernelSHAP method is stated to approximate conditional Shapley values via a weighted least square problem. However, the authors make an assumption of feature independence, in which case the conditional and marginal explanations coincide. Thus, the KernalSHAP method effectively approximates marginal game values. Regardless, the KernelSHAP method is still very expensive computationally when the number of predictors is large.

Another algorithm, called (path-dependent) TreeSHAP, introduced in Lundberg et al., “Consistent individualized feature attribution for tree ensembles”, ArXiv, arxiv:1802.03888 (2019), which is incorporated by reference herein in its entirety, is utilized to compute the Shapley value of a specially designed tree-based game which mimics the conditioning of the model by utilizing the tree-based model structure. The (path-dependent) TreeSHAP algorithm is a fast method, but in general it produces neither marginal nor conditional Shapley values (nor their approximants) when dependencies between predictors exist. This fact has been proven in Filom et al., “On marginal feature attributions of tree-based models,” which has a last revised date of Aug. 25, 2023, and can be found at https://arxiv.org/abs/2302.08434, and which is incorporated by reference herein in its entirety. In terms of complexity, the path-dependent algorithm runs in O(T·L·log(L)²) time, where T is the number of trees comprising the model and L is the maximum number of leaves. For one to obtain marginal Shapley values, an adaptation of the TreeSHAP algorithm was proposed called Independent (or Interventional) TreeSHAP, described in Lundberg et al., “From local explanations to global understanding with explainable AI for trees”, Nature Machine Intelligence 2, 56-67 (2020), which is incorporated herein by reference in its entirety. It is not as fast as the path-dependent version of the algorithm since it must average over a background dataset D̅_{X} to compute the empirical marginal expectations. However, the complexity is linear in the number of samples, and specifically (path-dependent) TreeSHAP has complexity O(T·|D_{X}|·L), where again T is the number of trees and L is the maximum number of leaves. Note that the values produced by TreeSHAP are model-specific and, in the case of the path-dependent algorithm, they depend on the make-up of the tree-model ƒ(x) in terms of trees: for two different make-ups of some tree-based model ƒ(x), the attribution values will in general differ, which is not always desirable for an application such as the production of reason codes.

In practice, both KernelSHAP or TreeSHAP algorithms can be utilized to compute the (Shapley value-based) attribution for each group of input variables defined by the clustering algorithm (e.g., PROC VARCLUS clustering algorithm), which is done by computing the attribution for each individual input variable using the KernelSHAP or TreeSHAP algorithm and then summing the attributions across each group in line with Equation 4 above. Once the group attribution value is calculated for each group of input variables, the groups of input variables can be ranked in descending order of Shapley values. It is important to emphasize again that KernelSHAP is limited in its application when the number of features is large and TreeSHAP is limited because it is a model-specific algorithm, and its path-dependent version produces attributions that are not guaranteed to be conditional Shapley values.

In general, a marginal Shapley value may represent, for a given data record x that was scored by a trained model object ƒ(x), a value (e.g., an “explainer” value) for each input variable that indicates the input variable's contribution to the model's output score for the given data record. For example, if a trained model object is a regressor score (i.e., a probability value with value between 0 and 1) a marginal Shapley value may be expressed as a number between −1 and 1, with a positive value indicating a positive contribution to the output and a negative value indicating a negative contribution to the output. Further, the magnitude of the marginal Shapley value may indicate the relative strength of its contribution.

In this regard, it will be understood that a marginal Shapley value for a given input variable must be interpreted in view of how the data science model defines its output. Returning to the example discussed in FIG. 2 above, the model object 204 may be trained to output a score that indicates a risk level of an individual, where a higher score indicates a higher risk. Accordingly, a positive Shapley value for any of the input variables X₁, X₂, . . . X₂ in FIG. 2 would indicate that the input variable contributed to pushing the risk score higher. On the other hand, a negative Shapley value for any of the input variables X₁, X₂, . . . Xₙ would indicate that the input variable contributed to pushing the risk score lower.

One important difference between the marginal and conditional Shapley values is that the marginal values (unlike conditional Shapley values) are in general not stable in any metric (naturally) relying on the joint distribution of features (unless feature variables are independent, in which case the marginal and conditional Shapley values are equal and hence both stable). This means that under dependencies in predictors X, for two trained models that have similar predictions (on average), the marginal Shapley values between the models may differ significantly (on average). This fact has been rigorously established in the paper noted above by Miroshnikov et al. (2022).

It is important to emphasize that one of the drawbacks of the explainer techniques discussed above is that they fail to account for dependencies between input variables (this is relevant to both KernelSHAP and TreeSHAP). KernelSHAP generally treats all input variables as independent, which may not be the case in practice, while TreeSHAP relies on the structure of the regression trees that make up the model and its path-dependent version only partially respects dependencies.

One approach that allows to alleviate the difference between the marginal and conditional perspectives is an approach based on grouping predictors by dependencies and computing the attribution of the group by summing marginal Shapley values across each group as described above; such an approach is presented in the article of K. Aas et al. “Explaining individual predictions when features are dependent more accurate approximations to Shapley values”, Artificial Intelligence, 298 (2021). It has been observed by the authors of Aas et al. that forming groups by dependencies alleviates the inconsistencies and approximates the sums of conditional Shapley values. However, as shown in Miroshnikov et al. (2022), summing marginal Shapley values guarantees neither the stability (and consistency with data) nor equality with the sums of conditional Shapley values.

To address these and other shortcomings with the techniques discussed above, a model object's input variables can be arranged into groups based on their dependencies (e.g., using a clustering algorithm) such that within groups, predictors are dependent but across groups there are little to no dependencies (e.g., any dependency is below a threshold value). Once these groups are formed, their contributions can then be quantified using a game-theoretical explainer technique (based on the marginal game) that is capable of quantifying the contribution of variable groups, which guarantees that the marginal explanations of the group are equal to that of conditional ones. This approach may also be referred to as a group explainer or group attribution technique.

One such technique that applies this approach for determining the contribution value of a group of dependent variables is a technique based on Shapley values of the quotient marginal game, a game that treats groups as players. In this technique, which may be referred to as QSHAP, the input variables are first partitioned into groups based on their dependencies, and then the Shapley formula can be applied to give the contribution value for a group of input variables.

In another such technique, where contribution values for individual input variables within a group are desired, a two-step procedure may be used. One example of a contribution value that may be calculated in this way is an Owen value, which is obtained by playing a coalitional game that treats the individual input variables within a given variable group as players, nested within a quotient marginal game that treats the groups themselves as players. However, it can be difficult or impossible to determine Shapley values (including QSHAP values) or Owen values in practice, as the number of calculations that must be performed by the model object increases exponentially based on the number of groups and elements in each group that are present in the input data record, even for a small dataset D̅_{X}. For example, determining an empirical Shapley value for a model object with 30 input variables would require calculations numbering on the order of 230 times the size of the dataset. Further, many data science models in operation today may be configured to analyze hundreds or even thousands of input variables in a given input data record. This, in turn, may result in an exponential increase in the amount computational resources and ultimately, the amount of time that is required to determine a contribution value for just a single variable. In applications where contribution values are desired within a relatively short period of time after a given data science model renders a classification decision (e.g., generating an MRC upon denying a loan application), waiting an extended period of time for the techniques discussed above to perform an exact computation may not be a practical solution.

To address the aforementioned issues, the present inventors developed new techniques for approximating Shapley values and Owen values using Monte Carlo sampling on a product probability space of random coalitions and data records of features. In particular, an approach for approximating QSHAP group contribution values using Monte Carlo sampling is discussed in U.S. patent application Ser. No. 18/111,823 filed on Feb. 20, 2023 and entitled “COMPUTING SYSTEM AND METHOD FOR APPLYING MONTE CARLO ESTIMATION TO DETERMINE THE CONTRIBUTION OF DEPENDENT INPUT VARIABLE GROUPS ON THE OUTPUT OF A DATA SCIENCE MODEL,” which is incorporated herein by reference in its entirety.

Another approach for approximating Owen values using Monte Carlo sampling is discussed in U.S. patent application Ser. No. 18/111,825 filed on Feb. 20, 2023 and entitled “COMPUTING SYSTEM AND METHOD FOR APPLYING MONTE CARLO ESTIMATION TO DETERMINE THE CONTRIBUTION OF INDEPENDENT INPUT VARIABLES WITHIN DEPENDENT INPUT VARIABLE GROUPS ON THE OUTPUT OF A DATA SCIENCE MODEL,” which is incorporated herein by reference in its entirety.

Another approach for approximating contribution values using a two-step technique called Two-Step Shapley is discussed in U.S. patent application Ser. No. 18/111,826 filed on Feb. 20, 2023 and entitled “COMPUTING SYSTEM AND METHOD FOR APPLYING MONTE CARLO ESTIMATION TO DETERMINE THE CONTRIBUTION OF INDEPENDENT INPUT VARIABLES WITHIN DEPENDENT INPUT VARIABLE GROUPS ON THE OUTPUT OF A DATA SCIENCE MODEL,” which is incorporated herein by reference in its entirety

At a high level, Monte Carlo sampling generally involves the aggregation of repeated randomly sampled observations in order to obtain numerical results. In the context of determining a contribution value as discussed herein, a Shapley value for a variable of interest Xᵢ from the features X=(X₁, X₂, . . . Xₙ), i∈{1, . . . , n}=N, in an input data record x*, with a background dataset D̅_{X}, can be viewed as an expected value of

$$f ( {x}_{𝒮 ⋃ {S}_{i}}^{*} , {X}_{- ( 𝒮 ⋃ {S}_{i} )} ) - f ( {x}_{𝒮}^{*} , {X}_{- 𝒮} ) \qquad ( Eq . 5 )$$

where ƒ is a trained model object, and S:=∪_{i∈S}Sᵢ, where S⊆N\{i} is a random coalition not containing the variable of interest i. The probability of selecting S, or equivalently S∪{i}, is given by the corresponding coefficient in the Shapley value formula for n players, i.e., by

$$f \frac{( n - \vert s \vert - 1 ) ! \vert s \vert !}{n !} ,$$

and X is a random vector of features.

The difference in Equation 5 is between two synthetically created data records that are scored by the trained model object and describes an effect of the variable of interest in an input data record on the model object's output. Given a number of iterations n_{mc}≤|D̅_{X}|, the Monte Carlo sampling repeatedly evaluates the above difference by iterating through the list of the first n_{mc} observations in the background dataset D̅_{X}, which is assumed to be randomly perturbed. For the k-th iteration, one samples non-uniformly a coalition, according to the distribution described above, to form a pair containing the k-th observation and the sampled coalition that are used to create a pair of synthetic samples. Finally, after iterating n_{mc} times, the results are averaged to produce an approximation of the Shapley value for the variable of interest.

By applying Monte Carlo sampling in this way, these techniques allow for the calculation of Shapley and Owen values in a more efficient manner that requires fewer calculations, fewer computational resources, and less time than an exact computation would otherwise require. Various other advantages associated with this type of Monte Carlo sampling are discussed in the applications noted above.

Nonetheless, the Monte Carlo sampling approaches discussed above can be susceptible to computational bottlenecks when the number of input variables n is very large. In particular, consider the Shapley formula presented in Equation 1 above, which provides that the coalitions of players S∪N\{i}. In other words, the coalitions S that are used to evaluate the Shapley formula are conditioned on not including the player of interest {i}. The same dependence on {i} can also be seen in Equation 5, where Monte Carlo sampling is used to estimate an expected value based on randomly sampled coalitions S that do not include the variable of interest Xᵢ. In the Monte Carlo context, the probability distribution, given by the Shapley coefficients noted above, over which the Monte Carlo algorithm samples coalitions (for computation of the attribution for feature i) is dependent on {i}.

As a result, the coalitions that are randomly sampled in each iteration of the Monte Carlo algorithm for a given input variable of interest cannot be re-used for the estimation of a contribution value of any other input variables. Because of this, coalitions have to be sampled separately for each feature, which increases complexity and storage of coalitions when the number of features is large and n_{mc} is large. For example, a computational bottleneck may result if the number of input variables n is very large, such as five thousand, and the number of Monte Carlo iterations n_{mc} to be performed is also large, such as one million. In this example, a random coalition must be sampled a total of five billion times—one million samples for each input variable—which may be infeasible in terms of both computation time and hardware.

To reduce the number of computations, one might contemplate an alternative approach that involves randomly sampling coalitions for each iteration before the input data record to be scored is received, and before the Monte Carlo loop begins. Each of these coalitions, n_{mc} of them, may be stored as a vector (e.g., a vector of 0's and 1's) in a matrix having a size n_{mc}×n (with a file size for one matrix of n_{mc}·n bytes). Moreover, because the sampled coalitions are dependent on the variable of interest {i}, a matrix of this size must be stored for every {i} (which amounts to total file size of n_{mc}·n·n bytes). As above, when the number of input variable and Monte Carlo iterations gets very large, a computational bottleneck may result, this time due to the memory required to store n matrices of size n_{mc}×n. For the example above involving five thousand input variables and one million Monte Carlo iterations, thousands of terabytes would be needed.

In view of these challenges, disclosed herein is a new, faster approach for applying Monte Carlo sampling to estimate Shapley values that leverages a new technique for precomputing variable coalitions that are independent of the input variable of interest. Using this new approach, a single precomputed dataset of coalitions (e.g., represented by a matrix of 0's and 1's) can be generated and saved. This dataset of coalitions can then be used, along with a precomputed dataset of historical data records (e.g., also represented by a matrix), to construct each synthetic sample, for each input variable, that is evaluated by the model. As a result, estimations for Shapley values can be obtained more quickly and the computational requirements for doing so are decreased.

As a starting point for carrying out the new techniques discussed herein, the dependence on {i} must be removed from the probability distribution from which the coalitions are sampled. This probability distribution is given by the Shapley coefficients

$$\frac{s ! ( n - s - 1 ) !}{n !}$$

where, as noted above, S∪N\{i}. Note, however, that if coalitions are permitted to include {i}, the result of the sum expressed in the Shapley formula of Equation 1 does not change. In particular, S∪{i}, representing the union of the coalition S with {i}, is simply the coalition S if S already includes {i}. Therefore, the difference (ν(S∪{i})−ν(S)) is zero for coalitions S that include {i}. This allows one to express Equation 1 using summations over all coalitions S∪N of size n−1:

$${φ}_{i} [ v ] = {Σ}_{S ⊆ N , \vert S \vert \leq n - 1} \frac{s ! ( n - s - 1 ) !}{n !} ( v ( S ⋃ \{ i \} ) - v ( S ) ) . \qquad ( Eq . 6 )$$

However, because more coalitions are now being considered, the coefficients (in the adjusted Shapley formulation above) no longer sum to 1 in the evaluation of the formula. Therefore, the sum in Equation 1 no longer represents an expectation and cannot be used to approximate Shapley values, as written. To address this issue, a factor is introduced to the Shapley formula such that an expectation is once again given by

$${φ}_{i} [ N , v ] = {Σ}_{S ⊆ N , \vert S \vert \leq n - 1} \frac{1}{n} \frac{s ! ( n - s ) !}{n !} \cdot ( ( v ( S ⋃ \{ i \} ) - v ( S ) ) \cdot ( \frac{n}{n - s} ) ) \qquad ( Eq . 7 )$$

As can be seen from Equation 7, the dependence on {i} has been removed form the probability distribution, which is now given by

$${P}_{+} ( S = S ) = \frac{1}{n} \frac{s ! ( n - s ) !}{n !}$$

for S∈{S∪N, |S|≤n−1}. If a marginal game ν^{ME} is then assumed, using this modified probability distribution, the Shapley value for a variable of interest {i} can be taken as:

$${φ}_{i} [ N , {v}^{M E} ( \cdot , x ; X , f ) ] = \int \int ( ( f ( {x}_{S ⋃ \{ i \}} , {\tilde{x}}_{- ( S ⋃ \{ i \} )} ) - f ( {x}_{{S}_{i}} , {\tilde{x}}_{- S} ) ) \cdot ( \frac{n}{n - \vert S \vert} ) ) {P}_{+} ( d S ) ⊗ {P}_{X} ( d \tilde{x} ) \qquad ( Eq . 8 )$$

Alternatively, the Shapley value for a variable of interest {i} can be expressed as:

$${φ}_{i} [ N , {v}^{M E} ( \cdot , x ; X , f ) = {𝔼}_{( S , \tilde{x} ) ∼ {P}_{+} ⊗ {P}_{X}} [ ( f ( {x}_{S ⋃ \{ i \}} , {\overline{x}}_{- ( S ⋃ \{ i \} )} ) - f ( {x}_{{S}_{i}} , {\overline{x}}_{- S} ) ) \cdot ( \frac{n}{n - \vert S \vert} ) ] \qquad ( Eq . 9 )$$

This, in turn, leads to a modified version of Equation 5 that can be used to estimate contribution values via Monte Carlo sampling. In particular, a Shapley value for a variable of interest Xᵢ from the features X=(X₁, X₂, . . . Xₙ), i∈{1, . . . , n}=N, in an input data record x*, with a background dataset \dot{D}_{X}, can be viewed as an expected value of

$$( f ( {x}_{𝒮 ⋃ {S}_{i}}^{*} , {X}_{- ( 𝒮 ⋃ {S}_{i} )} ) - f ( {x}_{𝒮}^{*} , {X}_{- 𝒮} ) ) ( \frac{n}{n - s} ) \qquad ( Eq . 10 )$$

where ƒ is a trained model object, and [symbol] :=∪_{i∈S}Sᵢ, where S∪N is a random coalition, independent of the variable of interest i, having size |S|≤n−1. The probability of selecting S, or equivalently S∪{i}, is given by the corresponding coefficients in the modified Shapley value formula for n players, i.e., by

$$\frac{1}{n} \frac{s ! ( n - s ) !}{n !} ,$$

and X is a random vector of features from the background dataset.

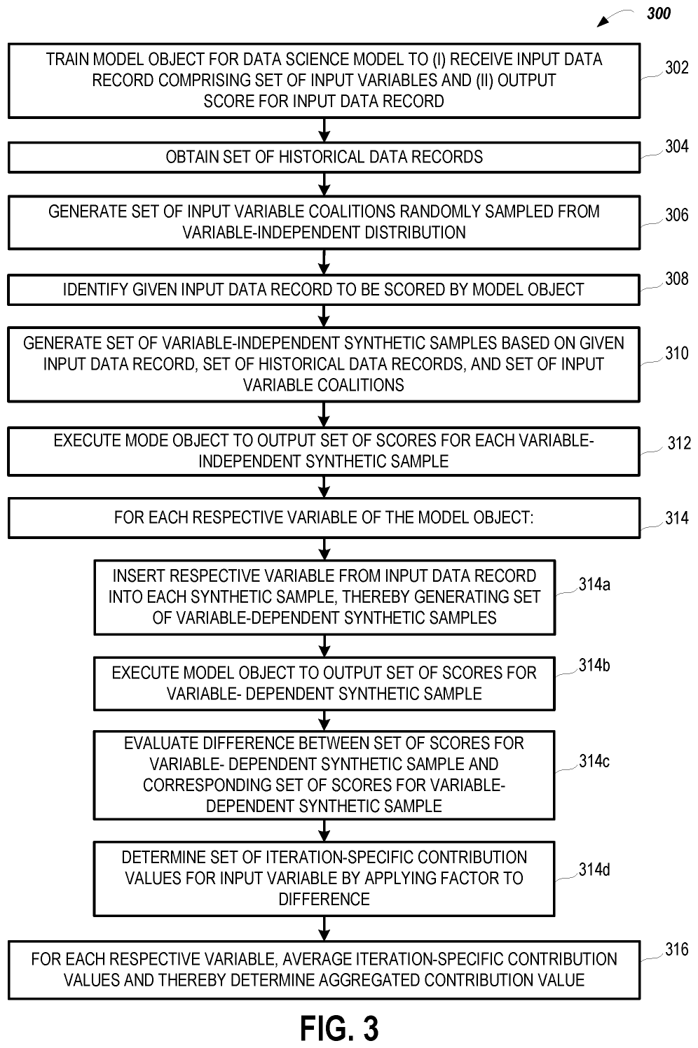

Turning to FIG. 3, a flow chart is shown that illustrates one example of a process 300 that uses a matrix of precomputed, variable-independent coalitions to approximate marginal Shapley values using Monte Carlo sampling techniques in accordance with the present disclosure. The example process 300 of FIG. 3 may be carried out by any computing platform that is capable of creating a data science model, including but not limited to the computing platform 102 of FIG. 1, which will be referred to in the following examples. Further, it should be understood that the example process 300 of FIG. 3 is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 3, the example process 300 may begin at block 302 with the computing platform 102 training a model object for a data science model that is to be deployed by an organization for use in making a particular type of decision. In general, this model object may comprise any model object that is configured to (i) receive an input data record related to a respective individual for a particular set of input variables (which may also be referred to as the model object's “features” or the model object's “predictors”), (ii) evaluate the received input data record, and (iii) based on the evaluation, output a score that is then used make the given type of decision with respect to the respective individual. Further, the specific model object model that is trained may take any of various forms, which may depend on the particular data science model that is to be deployed.

For instance, as one possibility, the model object that is trained at block 302 may comprise a model object for a data science model to be utilized by an organization to decide whether or not to extend a particular type of service (e.g., a financial service such as a loan, a credit card account, a bank account, or the like) to a respective individual within a population. In this respect, the set of input variables for the model object may comprise data variables that are predictive of whether or not the organization should extend the particular type of service to a respective individual (e.g., variables that provide information related to credit score, credit history, loan history, work history, income, debt, assets, etc.), and the score may indicate a likelihood that the organization should extend the particular type of service to the respective individual, which may then be compared to a threshold value in order to reach a decision of whether or not to extend the particular type of service to the respective individual.

The function of training the model object may also take any of various forms, and in at least some implementations, may involve applying a machine learning process to a training dataset that is relevant to the particular type of decision to be rendered by the data science model (e.g., a set of historical data records for individuals that are each labeled with an indicator of whether or not a favorable decision should be rendered based on the historical data record). In this respect, the machine learning process may comprise any of various machine learning techniques, examples of which may include regression techniques, decision-tree techniques, support vector machine (SVM) techniques, Bayesian techniques, ensemble techniques, gradient descent techniques, and/or neural network techniques, among various other possibilities.

For the remaining blocks of the process 300 shown in FIG. 3, an ongoing example will be discussed that uses a consistent notation to help illustrate various aspects of the techniques discussed herein. In particular, assume that the model object that was trained in block 302 was trained using a dataset D_{X} that includes one million input data records, and further assume that the model object obtains a set of historical data records (e.g., a background dataset) that is randomly sampled from the training set. This set of historical data records, referred to as D̅_{X} above, will be expressed as X_{mc} for purposes of the ongoing example below. Further, assume that the trained model object is configured to receive an input vector X that includes the input variables X₁, X₂, X₃, X₄, . . . X_{5,000}. In this regard, the model object may be represented as a function ƒ(x₁, x₂, x₃, x₄, . . . , x_{5,000})=ƒ(x) that outputs a score for a given input data record that includes values for each of the input variables.

At block 304, the computing platform 102 may obtain the set of historical data records X_{mc}, which may be represented as a matrix of size n_{mc}×n—which in the present example is a matrix having one million rows and five thousand columns. The computing platform 102 may obtain the set of historical data records in various ways. As one possibility, the computing platform 102 may undertake the random sampling of the training dataset Pₓ until the desired one million samples for X_{mc} are obtained. As another possibility, the set of historical data records may be provided to the computing platform 102 from another source. Other examples are also possible.

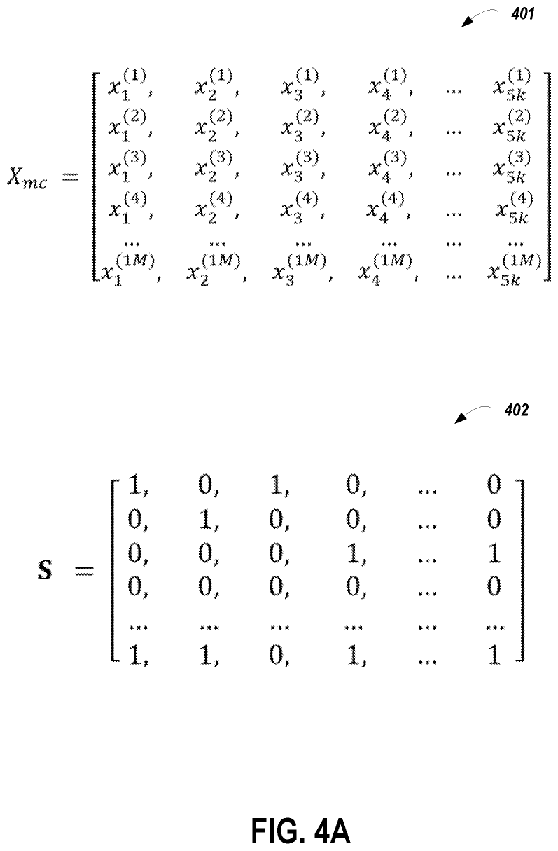

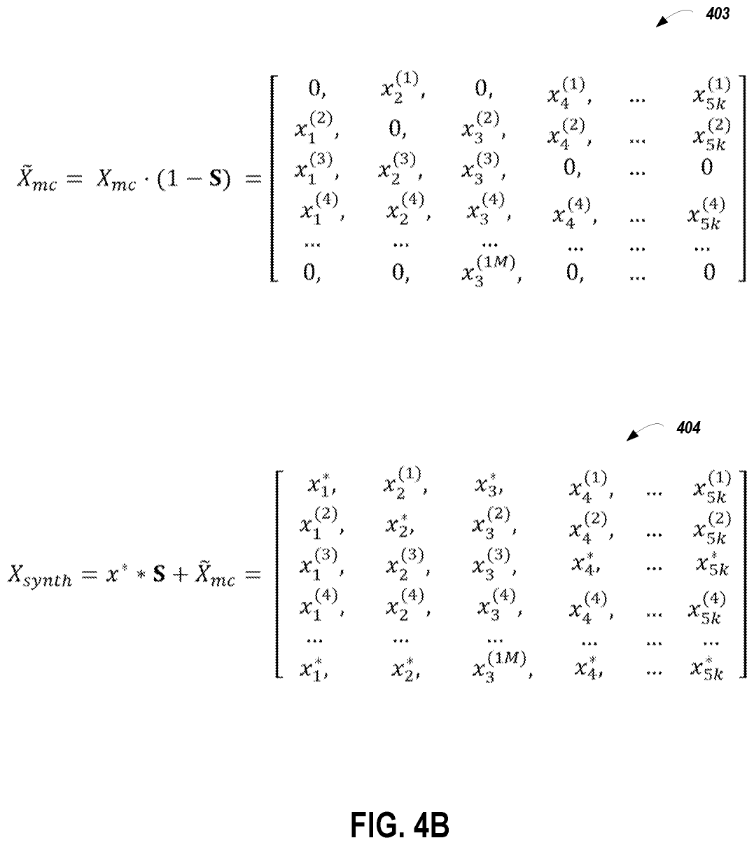

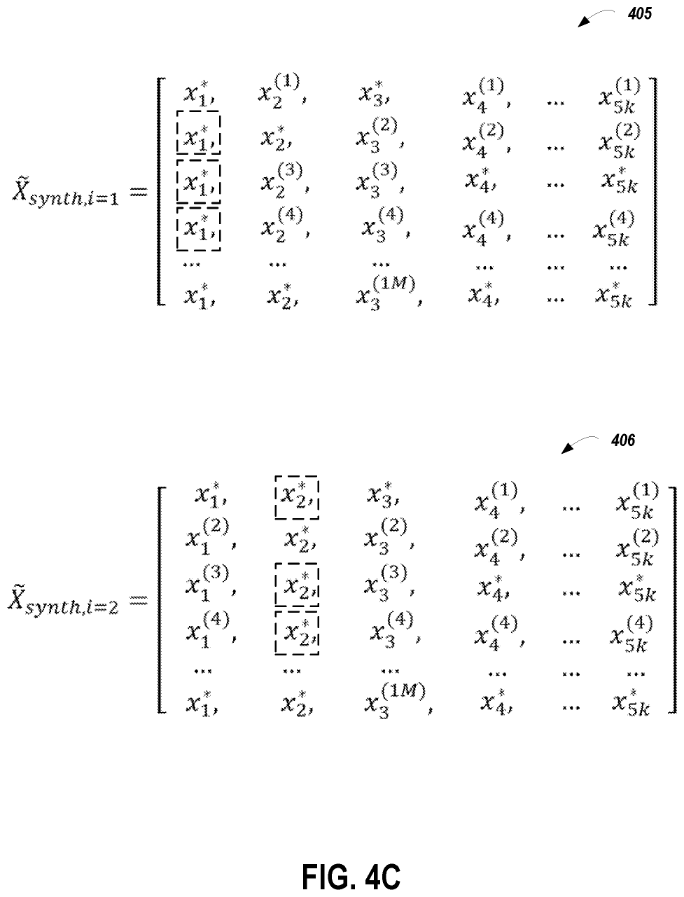

FIG. 4A illustrates an example set of historical data records X_{mc}, which takes the form of a matrix 401 where each row is a vector x^{(k)} that represents one of the one million (1M) sampled historical data records, where k∈{1, 2, . . . 1M}. Each historical data record x^{(k)} includes five thousand (5 k) variables and may be represented by

$${x}^{( k )} = ( {x}_{1}^{( k )} , {x}_{2}^{( k )} , {x}_{3}^{( k )} , {x}_{4}^{( k )} , … {x}_{5 k}^{( k )} )$$

At block 306, the computing platform 102 may generate a set of variable coalitions by randomly sampling from a distribution of the set of input variables that is independent of any input variable. The set of variable-independent coalitions may take the form of a matrix S having the same size as X_{mc}, where each row in the matrix S is a vector of 1's and 0's that represent the respective presence or absence of a given input variable in the coalition. For example, in the k^{th} row of the matrix S, a 1 in the i^{th} column means that the corresponding i^{th} input variable is a part of the k^{th} coalition, whereas a 0 the i^{th} column means that the corresponding i^{th} input variable is not a part of the k^{th} coalition. FIG. 4A illustrates an example set of variable coalitions S, which takes the form of a matrix 402.

To generate the matrix S, the computing platform 102 may randomly select each coalition (distributed according to the probabilities given by the corresponding coefficients of the modified Shapley value formula with five thousand players, i.e., the probabilities presented above in relation to Equations 6 and 7) in various ways. As one possibility, to generate the k^{th} coalition, the computing platform 102 may first generate the size of the coalition |S|∈{0, 1, 2, 3, . . . n−1} uniformly at random on {0, 1, 2, 3, . . . n−1}, where n is the number of input variables. Once a size of the coalition is generated, representing the number of 1's that will be included in the k^{th} row of matrix S, the computing platform 102 may insert the 1's into randomly selected columns of the k^{th} row, leaving all other columns 0. As another possibility, once a size of the coalition is generated, the computing platform 102 may generate a list of all possible variable coalitions of size |S| and then randomly select a variable coalition from the list.

Further, it should be noted that the random selection of coalitions for inclusion in the matrix S is non-uniform. This is because the probability of occurrence of each possible coalition must correspond to the probability given by the corresponding coefficients of the adjusted Shapley value formula shown in Equation 7 with n players, where n is the number of variables. Specifically, a coalition S⊆{0, . . . n−1} corresponding to the union of features S=∪_{i∈S}Sᵢ, has a probability of occurrence

$$\frac{( n - \vert s \vert - 1 ) ! \vert s \vert !}{n !} .$$

Other implementations for selecting a random variable coalition in a way that incorporates the probability of each coalition are also possible.

Once generated, the matrix S may be stored by the computing platform 102 for future use, as further discussed below. In contrast to the approaches discussed above, note that the set of variable coalitions S does not depend on the variable of interest and can therefore be stored and reused for every input variable of the model object. Thus, rather than sampling five thousand variable-dependent sets of coalitions-one set for each input variable-only the single variable-independent set of variable coalitions S is needed.

At this stage, prior to identifying a given input data record to be scored by the model object, note that the computing platform 102 can precompute several components of the expectation shown in Equation 10. For example, note that the term X_{-S}, which represents the portion of a synthetic sample that excludes the coalition, can be represented by a set of coalitions where the 0's in each coalition are replaced by the corresponding input variable from the set of historical data records. This dataset is given by

$${X}_{m c} \cdot ( 1 - S )$$

the result of which is a matrix \tilde{X}_{mc} produced based on a row by row multiplication the set of historical data records X_{mc} and the set of variable coalitions S, both of which are already stored by the computing platform 102. An example of this dataset \tilde{X}_{mc} is shown in FIG. 4B, represented by the matrix 403. As can be seen with reference to the set of historical data records X_{mc} and the set of coalitions S shown in FIG. 4A, each of the 0's in the coalitions of S has been replaced with the corresponding variable from X_{mc}, and each of the 1's in the coalitions of S has been replaced by a 0. In this way, the dataset \tilde{X}_{mc} can be determined once, stored, and then reused for every new input data record that is to be scored, thereby reducing the overall number calculations that must be performed.

At block 308, the computing platform 102 may identify a given input data record that is to be scored by the model object, and for which the Shapley values are to be determined. The computing platform may identify the given input data record in various ways. For instance, the given input data record may correspond to an individual that is applying for a service (e.g., a loan) that is provided by a financial services company, and the computing platform may receive the given input data record as part of the application process. The computing platform may identify the given input data record in other ways as well.

For purposes of notation in the ongoing simplified example, the given input data record and the values associated with its input variables may be represented by

$${x}^{*} = ( {x}_{1}^{*} , {x}_{2}^{*} , {x}_{3}^{*} , {x}_{4}^{*} , … {x}_{5 k}^{*} ) .$$

At this stage, after identifying a given input data record to be scored but prior to identifying a variable of interest and initiating a Monte Carlo loop, note that the computing platform 102 has now determined the information that is required to generate synthetic samples, which is nearly all of the information required to output contribution values according to the expectation of Equation 10. As a result, most of this expectation can be precomputed and then reused for every variable of interest.

Accordingly, at block 310, the computing platform 102 may generate a set of variable-independent synthetic samples that is independent of any input variable. For instance, the synthetic sample in the second half of the difference in Equation 10, given by [symbol] , can be taken as

$${x}^{*} * S + {\tilde{X}}_{m c}$$

the result of which is a dataset X_{synth} that is produced by the multiplication of the given input data record x* with each row of the set of coalitions S, which is then added to the dataset \tilde{X}_{mc} that was precomputed above. An example of this dataset x_{synth} is shown in FIG. 4B, represented by the matrix 404. As can be seen, the dataset x_{synth} is a set of vectors that each includes variables from the input data record x* where the input data record x* is a part of each coalition—i.e., where each coalition in the set of coalitions S includes a 1—and includes variables from the set of historical data records X_{mc} where the input data record x* is not a part of each coalition—i.e., where each coalition in the set of coalitions S includes a 0.

In this way, the dataset X_{synth} including synthetic samples to be scored by the model object can be determined once, stored, and then reused for every new input data record. Moreover, the difference in Equation 10 based in part on evaluating the function ƒ( [symbol] ), which as discussed above, uses the synthetic samples in the dataset X_{synth}.

Therefore, at block 312, the computing platform 102 may execute the model object to output a respective score for each synthetic sample in the set of synthetic samples that is independent of any input variable. The resulting set of scores can be given by

ƒ_{synth}=ƒ(X_{synth}).

Beneficially, this precomputation of ƒ_{synth} reduces by half the number of calls the computing platform 102 must make to the model object to score synthetic samples during execution of the Monte Carlo loop discussed below.

Starting at block 314, the computing platform 102 may begin running an iterative Monte Carlo loop for each given input variable, shown by sub-blocks 314a-314d, to estimate a contribution value for each input variable. At a high level, this computation may involve determining the difference between (i) an expected output of the model object for a first synthetic input data record that includes the current variable of interest included in the randomly-selected variable coalition and (ii) an expected output of the model object for a second synthetic input data record where the current variable of interest is not included in the variable coalition. Accordingly, the Monte Carlo loop operates to generate a set of variable-dependent synthetic samples that consider the current variable of interest, score the set of variable-dependent synthetic samples, and then evaluate the difference between the set of scores for the variable-dependent synthetic samples and the set of scores for the variable-independent synthetic samples, ƒ_{synth}, discussed above. A factor is then applied to the difference and the result is an iteration-specific contribution value for the input variable of interest.

An illustrative example is shown in FIG. 4C, in which the computing platform 102 determines a contribution value for the first variable of the input data record, and thus the input variable of interest is X₁. Accordingly, at block 314a, the computing platform 102 inserts the input variable xᵢ* from the input data record x* into each synthetic sample in the set of synthetic samples X_{synth} (i.e., in the first column of the matrix 404) that does not already include x₁*. As shown in FIG. 4C, this produces an input variable-dependent set of synthetic samples \tilde{X}_{synth,i=1}, represented by the matrix 405, where every value in the first column includes the input variable x₁*. In particular, the variables indicated by a dashed box in the matrix 405, which were formerly taken from the set of historical data records \tilde{X}_{mc}, have been replaced by the input variable x₁*. A similar result is shown in FIG. 4C for the second input variable input variable x₂*, resulting in another input variable-dependent set of synthetic samples \tilde{X}_{synth,i=2}, represented by the matrix 406. In the matrix 406, similar to the matrix 405, the variables indicated by a dashed box in the second column have been replaced by the input variable x₂*.

Based on the discussion above, it will be appreciated that some of the synthetic samples included in the updated set of synthetic samples \tilde{X}_{synth,i=1} do not change as a result of this insertion of the the input variable x; from the input data record x*. In these instances, the difference between the corresponding scores of the synthetic samples will be equal to zero and will have no effect on the estimated contribution value.

At block 314b, the computing platform 102 executes the model object to evaluate the updated set of synthetic samples \tilde{X}_{synth,i} (for the given feature Xᵢ), thereby obtaining a set of scores for the synthetic samples that include the variable of interest in each respective coalition.

At block 314c, the computing platform 102 evaluates the difference between the set of scores obtained at block 314b and the set of scores for the synthetic samples that did not include the variable of interest, ƒ_{synth}. In this regard, the difference for the given feature Xᵢ may be represented by a vector of length n_{mc}. Similarly, the difference for every feature may be represented by a matrix of values having size n_{mc}×n, where a respective difference is calculated for each Monte Carlo sample.

Further, note that the matrix of input variable-dependent sets of synthetic samples \tilde{X}_{synth,i=1} does not need to be stored after it is used to compute the difference as discussed above. Rather, for each given input variable Xᵢ, the column i in the matrix X_{synth} is returned to its original values and then the next column i+1 is replaced with xᵢ₊₁*, corresponding to the next input variable in the input data record x*, and so on.

At block 314d, the computing platform 102 determines a set of iteration-specific contribution values for the input variable of interest by applying a factor to the difference. With reference to Equation 10, the factor for the k^{th} difference is given by

$$\frac{n}{n - \vert S \vert}$$

and is therefore based on a total number of input variables n and the size |S| of the k^{th} coalition in the set of variable coalitions S.

At block 316, after the set of iteration-specific contribution values for the current variable of interest are calculated, the computing platform 102 may average the iteration-specific contribution values thereby determine an aggregated contribution value for the current variable of interest. This aggregated contribution value represents the estimated Shapley value for the current variable of interest.

The computing platform 102 may perform the averaging in block 316 in various ways. For instance, the computing platform may determine a mean of all the iteration-specific contribution values, across all iterations for the current variable of interest. This averaging may be represented by the following:

$${φ}_{i} ( x ) := Mean ( ( f ( {\tilde{X}}_{synth , i} ) - {f}_{s y n t h} ) \cdot ( \frac{n}{n - \vert S \vert} ) ) \qquad ( Eq . 11 )$$

The computing platform may determine the aggregated contribution value from the iteration-specific contribution values in other ways as well.

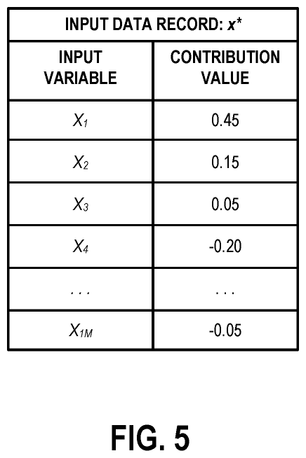

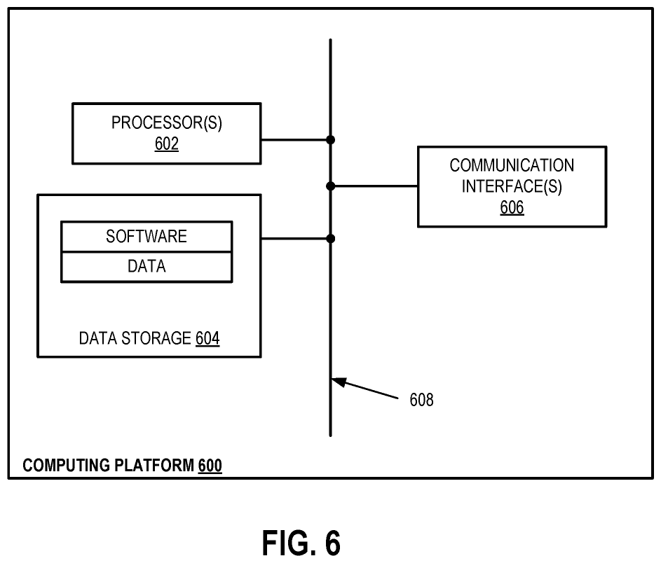

Turning now to FIG. 5, one possible output of the Monte Carlo analysis discussed above is shown, where a Shapley value for each of the input variables has been determined for the model object's output for the given input data record x*. As shown in FIG. 6, the Shapley value for the input variable X₁ is 0.45. This scalar value may indicate that the input variable X₁ has a relatively strong positive contribution to the particular type of decision that is made based on the model object's output, while the Shapley value of 0.15 for input variable X₂ indicates a positive contribution that is somewhat less strong, and the Shapley value of 0.05 for input variable X₃ indicates a relatively minimal positive contribution. On the other hand, the Shapley value shown in FIG. 6 for the input variable X₄ is −0.20. This scalar value may indicate that the variable X₄ has a relatively moderate negative contribution to the particular type of decision that is made based on the model object's output while the Shapley value of −0.05 for input variable X_{1M} indicates a relatively minimal negative contribution.

The example contribution values shown in FIG. 5 may provide various insights, depending on how the output of the model object in question is defined. For instance, consider one of the example data science models discussed above that is configured to render a decision regarding whether to extend a service being offered by an organization to an individual (e.g., a financial service such as a loan, a credit card account, a bank account, etc.). The data science model may render a decision based on an output score of the trained model object that estimates a risk level of the individual, where a higher score indicates a higher risk. In this example, the contribution value of 0.45 for the input variable X₁ indicates that the input variable X₁ made a relatively strong contribution to the output of the model object, pushing the estimated risk level of the individual higher. If the output score of the model for the input data record x* was high enough (e.g., above a threshold), the data science model may have rendered a decision not to offer the service to the individual. In this scenario, the Shapley value of 0.45, which has the largest contribution of any of the input variables, may be used as the basis to determine an MRC, which may be provided to the individual as the reason for the adverse decision.

Conversely, the contribution value of −0.20 for the input variable X₄ indicates that the input variable X₄ made a relatively moderate negative contribution to the output of the model, pushing the estimated risk level of the individual lower. In some cases, a negative contribution such as the one provided by X₄ may operate to mitigate the effects of a positive contribution. For example, due to the contribution of X₄, the output of the model object may not be above the threshold for the data science model to render an adverse decision.

In this regard, it will be appreciated that the Shapley values discussed herein may provide valuable insights, even in situations where the data science model does not render a particular decision that requires explanation. For example, consider a data science model that is configured to render a decision regarding the likelihood of failure of an industrial asset based on an analysis of operational data for the industrial asset (e.g., sensor data, actuator data, etc.). In this scenario, the Shapley values of each input variable may be calculated and considered for decisions where the model determined a likelihood of failure, such that remedial action that may be taken to avoid or fix the problem before the failure occurs in the given asset and/or in other similarly situated assets. In addition, a computing platform executing the data science model may additionally consider the Shapley values of each input variable for some decisions where the model did not determine a likelihood of failure.

For instance, in view of the possibility that some input variables may negatively impact the model output and thereby reduce the likelihood of a failure prediction, there may be situations in which a particular input variable has a strong enough positive contribution that it would have caused an adverse decision (e.g., a failure prediction), but for the presence of another input variable's negative contribution that mitigated the positive effect. In these situations, even though the data science model has not rendered a decision predicting a failure of the asset, it may nonetheless be advantageous to identify any input variables that had a significant positive contribution to the model, such that pre-emptive maintenance may be considered.

Although the examples discussed above involve the estimation of Shapley values based on a marginal expectation, in practice the input variables to a trained model object may not be independent. However, the techniques above may be applied in situations where the input variables of a model object are first grouped according to their dependencies into a partition P. For example, the techniques above may be applied in a QSHAP analysis, where the set of randomly sampled variable coalitions S is instead a set randomly sampled variable groups from the partition P. Further, the approach discussed above can also be used in the estimation of Owen values and other two-step explainer techniques, where coalitions of variables are nested within coalitions of groups. For example, to estimate Owen values, a matrix of group coalitions is generated at the precomputation step, and then for each group of interest, a random coalition of input variables within the group of interest is added. Various other extensions are also possible.

Turning now to FIG. 6, a simplified block diagram is provided to illustrate some structural components that may be included in an example computing platform 600 that may be configured to perform some or all of the functions discussed herein for creating a data science model in accordance with the present disclosure. At a high level, computing platform 600 may generally comprise any one or more computer systems (e.g., one or more servers) that collectively include one or more processors 602, data storage 604, and one or more communication interfaces 606, all of which may be communicatively linked by a communication link 608 that may take the form of a system bus, a communication network such as a public, private, or hybrid cloud, or some other connection mechanism. Each of these components may take various forms.

For instance, the one or more processors 602 may comprise one or more processor components, such as one or more central processing units (CPUs), graphics processing units (GPUs), application-specific integrated circuits (ASICs), digital signal processor (DSPs), and/or programmable logic devices such as a field programmable gate arrays (FPGAs), among other possible types of processing components. In line with the discussion above, it should also be understood that the one or more processors 602 could comprise processing components that are distributed across a plurality of physical computing devices connected via a network, such as a computing cluster of a public, private, or hybrid cloud.

In turn, data storage 604 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 604 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 6, data storage 604 may be capable of storing both (i) program instructions that are executable by processor 602 such that the computing platform 600 is configured to perform any of the various functions disclosed herein (including but not limited to any the functions described above with reference to FIG. 3), and (ii) data that may be received, derived, or otherwise stored by computing platform 600.

The one or more communication interfaces 606 may comprise one or more interfaces that facilitate communication between computing platform 600 and other systems or devices, where each such interface may be wired and/or wireless and may communicate according to any of various communication protocols, examples of which may include Ethernet, Wi-Fi, serial bus (e.g., Universal Serial Bus (USB) or Firewire), cellular network, and/or short-range wireless protocols, among other possibilities.

Although not shown, the computing platform 600 may additionally include or have an interface for connecting to one or more user-interface components that facilitate user interaction with the computing platform 600, such as a keyboard, a mouse, a trackpad, a display screen, a touch-sensitive interface, a stylus, a virtual-reality headset, and/or one or more speaker components, among other possibilities.

It should be understood that computing platform 600 is one example of a computing platform that may be used with the embodiments described herein. Numerous other arrangements are possible and contemplated herein. For instance, other computing systems may include additional components not pictured and/or more or less of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one processor;
non-transitory computer-readable medium; and
program instructions stored on the non-transitory computer-readable medium that are executable by the at least one processor such that the computing platform is configured to:
train a model object for a data science model using a machine learning process, wherein the model object is trained to (i) receive an input data record comprising a set of input variables and (ii) output a score for the input data record;
obtain a set of historical data records;
generate a set of variable coalitions by randomly sampling from a distribution of the set of input variables, wherein the distribution is independent of any input variable;
identify a given input data record to be scored by the model object;
generate a set of synthetic samples that is independent of any input variable, the set of synthetic samples generated based on (i) the given input data record, (ii) the set of historical data records, and (iii) the set of variable coalitions;
execute the model object to output a respective score for each synthetic sample in the set of synthetic samples;
for each respective input variable of the model object:
insert the respective input variable from the input data record into each synthetic sample that does not already include the respective input variable, thereby generating a variable-dependent set of synthetic samples;
execute the model object to output a set of scores for each variable-dependent synthetic sample in the set of variable-dependent synthetic samples;
evaluate a difference between the set of scores for each variable-dependent synthetic sample in the set of variable-dependent synthetic samples and the corresponding set of scores for each synthetic sample in the set of synthetic samples; and
determine a set of iteration-specific contribution values for the respective input variable by applying a factor to the difference, the factor based on (i) a total number of input variables in the set of input variables and (ii) a size of the corresponding respective coalition in the set of variable coalitions; and
for each respective input variable of the model object, average the iteration-specific contribution values determined for each iteration and thereby determine an aggregated contribution value for the respective input variable.

2. The computing platform of claim 1, wherein the program instructions that are executable by the at least one processor such that the computing platform is configured to generate a set of variable coalitions comprise program instructions that are executable by the at least one processor such that the computing platform is configured to:
generate a matrix of variable coalitions, where each row in the matrix is a vector of 1's and 0's that represent, for a corresponding coalition in the set of variable coalitions, a respective presence or absence of a given input variable in the variable coalition.

3. The computing platform of claim 2, wherein the program instructions that are executable by the at least one processor such that the computing platform is configured to generate the matrix of variable coalitions comprise program instructions that are executable by the at least one processor such that the computing platform is configured to:
for each variable coalition in the set of variable coalitions:
randomly generate a number of input variables in the variable coalition; and
insert, into the corresponding row of the matrix of variable coalitions that corresponds to the variable coalition, the number of 1's into randomly selected columns of the corresponding row, leaving all other columns 0.

4. The computing platform of claim 2, further comprising program instructions that are executable by the at least one processor such that the computing platform is configured to:
store the matrix of variable coalitions for reuse by the computing platform.

5. The computing platform of claim 2, further comprising program instructions that are executable by the at least one processor such that the computing platform is configured to:
generate a matrix of partial synthetic samples that exclude a portion of each synthetic sample from the corresponding coalition, wherein the matrix of partial synthetic samples includes (i) a 0 where each row in the matrix of variable coalitions includes a 1 and (ii) a corresponding variable from the set of historical data records where each row in the matrix of variable coalitions includes a 0.

6. The computing platform of claim 2, wherein the program instructions that are executable by the at least one processor such that the computing platform is configured to generate the set of synthetic samples that is independent of any input variable comprise program instructions that are executable by the at least one processor such that the computing platform is configured to:
generate a matrix of variable-independent synthetic samples, where each row in the matrix of variable-independent synthetic samples corresponds to a respective variable-independent synthetic sample and includes (i) a corresponding variable from the given input data record where each row in the matrix of variable coalitions includes a 1 and (ii) a corresponding variable from the set of historical data records where each row in the matrix of variable coalitions includes a 0.

7. The computing platform of claim 1, wherein the set of input variables includes one thousand or more input variables.

8. The computing platform of claim 7, wherein the set of historical data records includes one million or more historical data records.

9. A non-transitory computer-readable medium, wherein the non-transitory computer-readable medium is provisioned with program instructions that, when executed by at least one processor, cause a computing platform to:
train a model object for a data science model using a machine learning process, wherein the model object is trained to (i) receive an input data record comprising a set of input variables and (ii) output a score for the input data record;
obtain a set of historical data records;
generate a set of variable coalitions by randomly sampling from a distribution of the set of input variables, wherein the distribution is independent of any input variable;
identify a given input data record to be scored by the model object;
generate a set of synthetic samples that is independent of any input variable, the set of synthetic samples generated based on (i) the given input data record, (ii) the set of historical data records, and (iii) the set of variable coalitions;
execute the model object to output a respective score for each synthetic sample in the set of synthetic samples;
for each respective input variable of the model object:
insert the respective input variable from the input data record into each synthetic sample that does not already include the respective input variable, thereby generating a variable-dependent set of synthetic samples;
execute the model object to output a set of scores for each variable-dependent synthetic sample in the set of variable-dependent synthetic samples;
evaluate a difference between the set of scores for each variable-dependent synthetic sample in the set of variable-dependent synthetic samples and the corresponding set of scores for each synthetic sample in the set of synthetic samples; and
determine a set of iteration-specific contribution values for the respective input variable by applying a factor to the difference, the factor based on (i) a total number of input variables in the set of input variables and (ii) a size of the corresponding respective coalition in the set of variable coalitions; and
for each respective input variable of the model object, average the iteration-specific contribution values determined for each iteration and thereby determine an aggregated contribution value for the respective input variable.

10. The non-transitory computer-readable medium of claim 9, wherein the program instructions that, when executed by at least one processor, cause the computing platform to generate a set of variable coalitions comprise program instructions that, when executed by at least one processor, cause the computing platform to:
generate a matrix of variable coalitions, where each row in the matrix is a vector of 1's and 0's that represent, for a corresponding coalition in the set of variable coalitions, a respective presence or absence of a given input variable in the variable coalition.

11. The non-transitory computer-readable medium of claim 10, wherein the program instructions that, when executed by at least one processor, cause the computing platform to generate the matrix of variable coalitions comprise program instructions that, when executed by at least one processor, cause the computing platform to:
for each variable coalition in the set of variable coalitions:
randomly generate a number of input variables in the variable coalition; and
insert, into the corresponding row of the matrix of variable coalitions that corresponds to the variable coalition, the number of 1's into randomly selected columns of the corresponding row, leaving all other columns 0.

12. The non-transitory computer-readable medium of claim 10, further comprising program instructions that, when executed by at least one processor, cause the computing platform to:
store the matrix of variable coalitions for reuse by the computing platform.

13. The non-transitory computer-readable medium of claim 10, further comprising program instructions that, when executed by at least one processor, cause the computing platform to:
generate a matrix of partial synthetic samples that exclude a portion of each synthetic sample from the corresponding coalition, wherein the matrix of partial synthetic samples includes (i) a 0 where each row in the matrix of variable coalitions includes a 1 and (ii) a corresponding variable from the set of historical data records where each row in the matrix of variable coalitions includes a 0.

14. The non-transitory computer-readable medium of claim 10, wherein the program instructions that, when executed by at least one processor, cause the computing platform to generate the set of synthetic samples that is independent of any input variable comprise program instructions that, when executed by at least one processor, cause the computing platform to:
generate a matrix of variable-independent synthetic samples, where each row in the matrix of variable-independent synthetic samples corresponds to a respective variable-independent synthetic sample and includes (i) a corresponding variable from the given input data record where each row in the matrix of variable coalitions includes a 1 and (ii) a corresponding variable from the set of historical data records where each row in the matrix of variable coalitions includes a 0.

15. The non-transitory computer-readable medium of claim 9, wherein the set of input variables includes one thousand or more input variables.

16. The non-transitory computer-readable medium of claim 15, wherein the set of historical data records includes one million or more historical data records.

17. A method carried out by a computing platform, the method comprising:
training a model object for a data science model using a machine learning process, wherein the model object is trained to (i) receive an input data record comprising a set of input variables and (ii) output a score for the input data record;
obtaining a set of historical data records;
generating a set of variable coalitions by randomly sampling from a distribution of the set of input variables, wherein the distribution is independent of any input variable;
identifying a given input data record to be scored by the model object;
generating a set of synthetic samples that is independent of any input variable, the set of synthetic samples generated based on (i) the given input data record, (ii) the set of historical data records, and (iii) the set of variable coalitions;
executing the model object to output a respective score for each synthetic sample in the set of synthetic samples;
for each respective input variable of the model object:
inserting the respective input variable from the input data record into each synthetic sample that does not already include the respective input variable, thereby generating a variable-dependent set of synthetic samples;
executing the model object to output a set of scores for each variable-dependent synthetic sample in the set of variable-dependent synthetic samples;
evaluating a difference between the set of scores for each variable-dependent synthetic sample in the set of variable-dependent synthetic samples and the corresponding set of scores for each synthetic sample in the set of synthetic samples; and
determining a set of iteration-specific contribution values for the respective input variable by applying a factor to the difference, the factor based on (i) a total number of input variables in the set of input variables and (ii) a size of the corresponding respective coalition in the set of variable coalitions; and
for each respective input variable of the model object, averaging the iteration-specific contribution values determined for each iteration and thereby determine an aggregated contribution value for the respective input variable.

18. The method of claim 17, wherein generating a set of variable coalitions comprises:
generating a matrix of variable coalitions, where each row in the matrix is a vector of 1's and 0's that represent, for a corresponding coalition in the set of variable coalitions, a respective presence or absence of a given input variable in the variable coalition.

19. The method of claim 18, wherein generating the matrix of variable coalitions comprises:
for each variable coalition in the set of variable coalitions:
randomly generating a number of input variables in the variable coalition; and
inserting, into the corresponding row of the matrix of variable coalitions that corresponds to the variable coalition, the number of 1's into randomly selected columns of the corresponding row, leaving all other columns 0.

20. The method of claim 18, wherein generating the set of synthetic samples that is independent of any input variable comprises:
generating a matrix of variable-independent synthetic samples, where each row in the matrix of variable-independent synthetic samples corresponds to a respective variable-independent synthetic sample and includes (i) a corresponding variable from the given input data record where each row in the matrix of variable coalitions includes a 1 and (ii) a corresponding variable from the set of historical data records where each row in the matrix of variable coalitions includes a 0.
